(19) United States
(12) Patent Application Publication
(10) Pub. No.: US 2023/0133878 A1
(43) Pub. Date: May 4, 2023

(54) SOFTWARE DEVELOPMENT TOOL AND SYSTEMS

(71) Applicant: Salesforce.com, inc., San Francisco, CA (US)

(72) Inventor: David KAYTES, San Francisco, CA (US)

(73) Assignee: Salesforce.com, inc., San Francisco, CA (US)

(21) Appl. No.: 17/513,727

(22) Filed: Oct. 28, 2021

(51) Int. Cl. G06F 8/34; G06F 8/10

(52) U.S. Cl. CPC G06F 8/34; G06F 8/10

(57) ABSTRACT

Disclosed are some implementations of systems, apparatus, methods and computer program products for implementing a software development tool that enables a set of computer-readable instructions to be requested and obtained in association with an element of a process flow represented in a layout. A set of specifications can be submitted in association with a request, where the set of specifications includes input-output value pairs. In response, the system can automatically generate a first set of computer-readable instructions according to the set of specifications, where the first set of computer-readable instructions implements a mapping between the input-output value pairs. In addition, the system can obtain a second set of computer-readable instructions according to the set of specifications, either from pre-existing software code or from individual(s) (e.g., software developer(s)) to whom the system has sent a request for computer-readable instructions. The system can replace the first set of computer-readable instructions with the second set of computer-readable instructions.

### COPYRIGHT NOTICE

A portion of the disclosure of this patent document contains material, which is subject to copyright protection. The copyright owner has no objection to the facsimile reproduction by anyone of the patent document or the patent disclosure as it appears in the United States Patent and Trademark Office patent file or records but otherwise reserves all copyright rights whatsoever.

### TECHNICAL FIELD

This patent document generally relates to systems and techniques associated with generation of layouts representing process flows. More specifically, this patent document discloses techniques for facilitating the generation of computer-readable code associated with process flow elements.

### BACKGROUND

“Cloud computing” services provide shared resources, applications, and information to computers and other devices upon request. In cloud computing environments, services can be provided by one or more servers accessible over the Internet rather than installing software locally on in-house computer systems. Users can interact with cloud computing services to undertake a wide range of tasks.

Existing design tools offer users the ability to design a layout representing a process flow. More particularly, these tools enable a user to manually manipulate icons representing process flow elements and associated connectors using drag-and-drop operations. Typically, these tools provide a pre-defined list of element types of elements for which icons can be selected for insertion into the layout.

### BRIEF DESCRIPTION OF THE DRAWINGS

The included drawings are for illustrative purposes and serve only to provide examples of possible structures and operations for the disclosed systems, apparatus, methods and computer program products for facilitating the generation of computer-readable code associated with process flow elements. These drawings in no way limit any changes in form and detail that may be made by one skilled in the art without departing from the spirit and scope of the disclosed implementations.

FIG. 1 shows a system diagram of an example of a system 100 in which a flow management system is implemented, in accordance with some implementations.

FIG. 2 shows a system diagram of an example of a flow management system 108, in accordance with some implementations.

FIG. 3A shows a diagram of an example of a graphical user interface (GUI) 300 that may be presented by a flow builder, in accordance with some implementations.

FIG. 3B shows a diagram of an example of another GUI 340 that may be presented by a flow builder, in accordance with some implementations.

FIG. 3C shows a diagram of an example of another GUI 360 that may be presented by a flow builder, in accordance with some implementations.

FIG. 3D shows a diagram of an example of another GUI 380 that may be presented by a flow builder, in accordance with some implementations.

FIG. 4 shows a process flow diagram 400 illustrating a method of a implementing a flow builder, in accordance with various implementations.

FIG. 5 shows a process flow diagram 500 illustrating a method of obtaining computer-readable instructions associated with an element of a process flow, in accordance with some implementations.

FIG. 6A shows a block diagram of an example of an environment 10 in which an on-demand database service can be used in accordance with some implementations.

FIG. 6B shows a block diagram of an example of some implementations of elements of FIG. 6A and various possible interconnections between these elements.

FIG. 7A shows a system diagram of an example of architectural components of an on-demand database service environment 900, in accordance with some implementations.

FIG. 7B shows a system diagram further illustrating an example of architectural components of an on-demand database service environment, in accordance with some implementations.

### DETAILED DESCRIPTION

Examples of systems, apparatus, methods and computer program products according to the disclosed implementations are described in this section. These examples are being provided solely to add context and aid in the understanding of the disclosed implementations. It will thus be apparent to one skilled in the art that implementations may be practiced without some or all of these specific details. In other instances, certain operations have not been described in detail to avoid unnecessarily obscuring implementations. Other applications are possible, such that the following examples should not be taken as definitive or limiting either in scope or setting.

In the following detailed description, references are made to the accompanying drawings, which form a part of the description and in which are shown, by way of illustration, specific implementations. Although these implementations are described in sufficient detail to enable one skilled in the art to practice the disclosed implementations, it is understood that these examples are not limiting, such that other implementations may be used and changes may be made without departing from their spirit and scope. For example, the operations of methods shown and described herein are not necessarily performed in the order indicated. It should also be understood that the methods may include more or fewer operations than are indicated. In some implementations, operations described herein as separate operations may be combined. Conversely, what may be described herein as a single operation may be implemented in multiple operations.

Some implementations of the disclosed systems, apparatus, methods and computer program products are configured to facilitate the generation of layouts representing process flows via a visual process flow builder. In some implementations, systems, apparatus, methods, and computer program products are configured to enable users to request components (e.g., element types) that are unavailable via the flow builder and the procurement of computer-readable code associated with the requested components.

Many software developers write code using traditional software coding methods. However, a number of “low-code” developers prefer creating a visual workflow using a process flow design tool such as a visual process flow builder.

Using a process flow design tool, a process flow may be designed through the generation of a layout that visually represents the process flow. Elements (e.g., components) represented in the layout may each correspond to a corresponding set of computer-readable instructions. The elements may be represented within the layout via corresponding icons. The icons representing the elements may be “connected” to one another within the layout through the use of connectors.

To design a layout representing a process flow, a user typically accesses a visual design tool. Generally, the design tool presents a set of user-selectable options that enable various element types to be selected by a user for addition of corresponding icons representing instances of the element types to a layout. Upon selection, the user can drag and drag-and-drop icons representing the selected element types to the desired positions in the layout. Unfortunately, there are instances in which an element type that performs a particular function does not yet exist in the user-selectable options that are available.

Typically, when a low-code developer cannot identify an element type that performs the desired function, they must ask a software developer to generate code that performs the desired function. In the meantime, the low-code developer must design around the missing element of the process flow and must wait to test the process flow until after the requested code is provided by the software developer. Unfortunately, this introduces a substantial delay into the process flow design process.

In accordance with various implementations, when a low-code developer is unable to locate an element type that operates as desired, they can submit a request for a set of computer-readable instructions for the missing element type. The request can be submitted in association with a particular location within a layout represented in a graphical user interface (GUI), where the layout represents a process flow. In addition, the low-code developer can submit, in association with the request, a set of specifications that defines the operation of the missing element type. More particularly, the set of specifications can include test cases including set(s) of values, where each set of values includes a set of input values and set of output values. In addition, the set of specifications can include a description that describes the desired operation of the requested code.

In some implementations, the system automatically generates a first set of computer-readable instructions configurable to: 1) maintain, for at least one set of values, a mapping between the set of input values and corresponding set of output values, and 2) responsive to receiving the set of input values of the set of values, identify the corresponding set of output values in the mapping and provide the identified set of output values. The system can store the first set of computer-readable instructions such that the first set of computer-readable instructions is associated with an icon, which may be represented at the location within the layout.

A low-code developer can continue to test the process flow even though the requested instructions have not been provided by a software developer. Rather, during execution of the process flow, the automatically generated first set of instructions operates to look up received input value(s) in the mapping to identify the corresponding output value(s) and outputs the identified output value(s).

The system may proceed with obtaining a second set of computer-readable instructions that operates as desired, either subsequent to or in parallel with the generation of the first set of computer-readable instructions. There are two different ways that the system may obtain the second set of computer-readable instructions.

First, the system can search for instructions that operate according to the specifications. More particularly, the system can determine whether a code module that operates according to the set of specifications already exists, where the code module is stored within the system or in storage accessible to the system.

Second, the system can transmit a request to recipient(s) for the requested code. For example, the system can request that a software developer or group of software developers develop the requested code. Once provided by the software developer(s), the system can automatically verify that the provided code satisfies the set of specifications provided by the low code developer. As another example, the system request that an administrator search the system for a code module associated with an element type that satisfies the specifications provided by the low code developer.

By automatically generating the first set of computer-readable instructions, the system enables a low code developer to continue developing and testing a process flow without waiting for the requested code to be provided by software developer(s). This expedites the process flow design process and transforms it from one performed in series with the generation of code for the non-existing element type to one that can be performed in parallel with the generation of code for the non-existing element type.

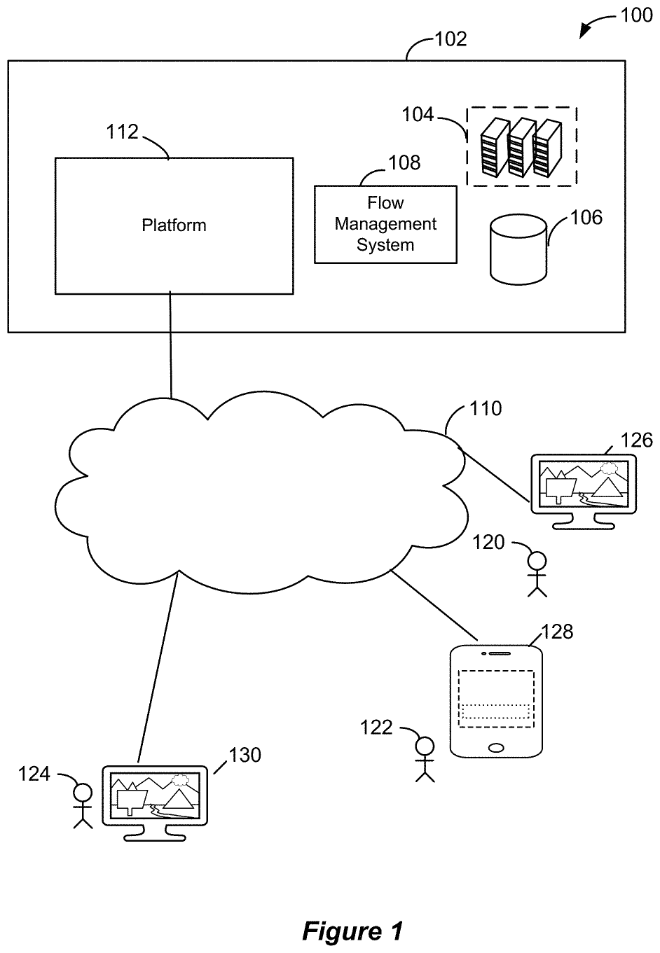

FIG. 1 shows a system diagram of an example of a system 100 in which a flow management system may be implemented, in accordance with some implementations. Database system 102 includes a variety of different hardware and/or software components that are in communication with each other. In the non-limiting example of FIG. 1, system 102 includes any number of computing devices such as servers 104. Servers 104 are in communication with one or more storage mediums 106 configured to store and maintain relevant data and/or metadata used to perform some of the techniques disclosed herein, as well as to store and maintain relevant data and/or metadata generated by the techniques disclosed herein. Storage mediums 106 may further store computer-readable instructions configured to perform some of the techniques described herein. Storage mediums 106 can also store user profiles of users of system 102, as well as database records such as customer relationship management (CRM) records such as those described herein.

System 102 includes server system 108, which can implement one or more web applications. As will be described in further detail below, flow management system 108 can facilitate the automated generation of computer-readable instructions associated with process flow elements (or associated process flow element types) that may not be available via flow management system 108, as well as facilitate obtaining computer-readable instructions configurable to implement a desired process flow element from software developers or other individuals.

In some implementations, system 102 is configured to store user profiles/user accounts associated with users of system 102. Information maintained in a user profile of a user can include a client identifier such an Internet Protocol (IP) address or Media Access Control (MAC) address. In addition, the information can include a unique user identifier such as an alpha-numerical identifier, the user's name, a user email address, and/or credentials of the user. Credentials of the user can include a username and password. The information can further include job related information such as a job title, role, group, department, organization, and/or experience level, as well as any associated permissions. Profile information such as job related information and any associated permissions can be applied by system 102 to manage access to web applications or services such as those described herein.

Client devices 126, 128, 130 may be in communication with system 102 via network 110. More particularly, client devices 126, 128, 130 may communicate with servers 104 via network 110. For example, network 110 can be the Internet. In another example, network 110 comprises one or more local area networks (LAN) in communication with one or more wide area networks (WAN) such as the Internet.

Embodiments described herein are often implemented in a cloud computing environment, in which network 110, servers 104, and possible additional apparatus and systems such as multi-tenant databases may all be considered part of the “cloud.” Servers 104 may be associated with a network domain, such as www.salesforce.com and may be controlled by a data provider associated with the network domain. In this example, employee users 120, 122, 124 of client computing devices 126, 128, 130 have accounts at Salesforce.com®. By logging into their accounts, users 126, 128, 130 can access the various services and data provided by system 102 to employees. In other implementations, users 120, 122, 124 need not be employees of Salesforce.com® or log into accounts to access services and data provided by system 102. Examples of devices used by users include, but are not limited to a desktop computer or portable electronic device such as a smartphone, a tablet, a laptop, a wearable device such as Google Glass®, another optical head-mounted display (OHMD) device, a smart watch, etc.

In some implementations, users 120, 122, 124 of client devices 126, 128, 130 can access services provided by system 102 via platform 112 or an application installed on client devices 126, 128, 130. More particularly, client devices 126, 128, 130 can log into system 102 via an application programming interface (API) or via a graphical user interface (GUI) using credentials of corresponding users 120, 122, 124 respectively.

Client devices 126, 128, 130 can communicate with flow management system 108 directly or via platform 112. Communications between client devices 126, 128, 130 and system 102 can be initiated by a user 120, 122, 124. Alternatively, communications can be initiated by system 102 and/or application(s) installed on client devices 126, 128, 130. Therefore, communications between client devices 126, 128, 130 and system 102 can be initiated automatically or responsive to a user request.

Some implementations may be described in the general context of computing system executable instructions, such as program modules, being executed by a computer. As disclosed herein, system 108 can execute instructions configurable to obtain a request for computer-readable instructions in association with a process flow element or element type. The disclosed implementations may further include computer-readable instructions, objects, data structures, and/or metadata, which may facilitate generating or obtaining computer-readable instructions in association with a process flow element (or associated with a process flow element type), as described herein.

Some implementations may also be practiced in distributed computing environments where tasks are performed by remote processing devices that are linked through a communications network. In a distributed computing environment, program modules may be located in local and/or remote computer storage media including memory storage devices.

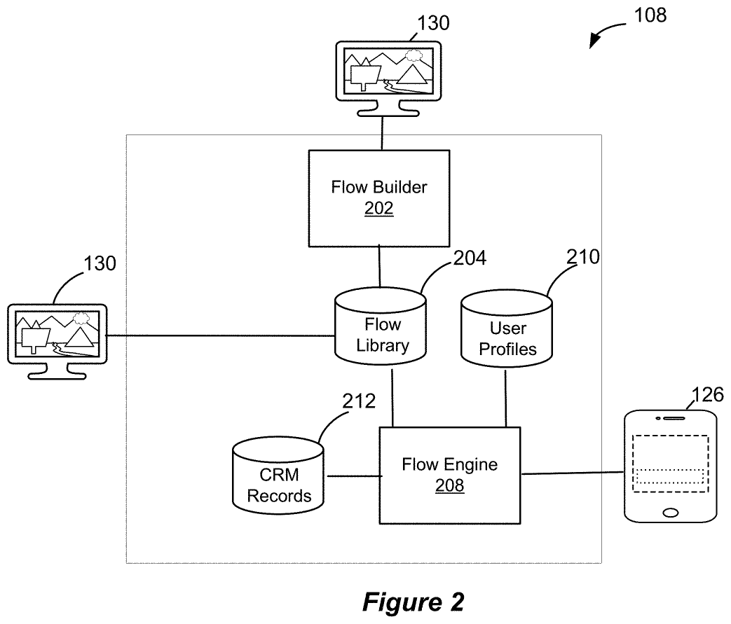

FIG. 2 shows a system diagram of an example of a flow management system 108, in accordance with some implementations. Flow management system 108 can include a flow builder 202 that enables a process flow to be generated using existing flows and/or other components. For example, an administrator, software developer, or other user may access flow builder 202 via computing device 130 to generate a layout representing a process flow including a plurality of elements.

In some implementations, the user may select a process flow type from a plurality of process flow types. The flow builder generates or obtains a user interface corresponding to the selected process flow type and provides the user interface for presentation via client device 130, where the user interface presents process flow element types that are user-selectable.

The user may select element types from the user interface and perform drag-and-drop operations to position corresponding icons representing elements within a layout representing a process flow. Flow builder 202 can generate a visual representation that represents the process flow in the form of a plurality of interconnected nodes that correspond to the elements of the process flow. The visual representation of the process flow may be provided for display via computing device 130, enabling the layout to be easily modified using drag-and-drop operations. As a user interacts with flow builder 202, a layout may be updated in real-time and provided for display via computing device 130, enabling the layout to be easily modified using click-based or drag-and-drop operations.

In some implementations, flow builder 202 enables a user to request computer-readable instructions associated with an element type that is either unavailable for selection by the user from the user interface or, alternatively, that the user is unable to locate within the user interface. Flow builder 202 is configurable to automatically generate a first set of computer-readable instructions responsive to the request according to a set of specifications provided by the user. Specifically, the set of specifications can include a set of values (e.g., test cases), where each set includes input value(s) and corresponding output value(s). In addition, the set of specifications can include a description that can guide the generation of the requested instructions by a software developer.

The first set of computer-readable instructions maintains a mapping between input value(s) and corresponding output value(s). During runtime, the first set of computer-readable instructions is configurable to provide, in response to receiving input value(s) of a set of values, the corresponding output value(s). This enables the process flow to be built and tested without waiting for computer-readable instructions for the missing element type to be developed by software developer(s).

Flow builder 202 may subsequently obtain a second set of computer-readable instructions that performs the desired function. More particularly, flow builder 202 can identify existing code module(s) in another part of system 102 or, alternatively, can request that the desired instructions be developed by a software developer. Once obtained, flow builder 202 can replace the first set of computer-readable instructions with the second set of computer-readable instructions. In this manner, software development of user-selectable reusable process flow components may be performed in parallel with process flow design. Once generated, a process flow may be stored in flow library 204. Each process flow may be identified by a corresponding flow identifier. A process flow may be stored in the form of a file that includes a set of computer-readable instructions.

In some implementations, an element and/or corresponding element type may be associated with a corresponding a set of computer-readable instructions that is executed during execution of a process flow including the element. For example, an element may have an associated application programming interface (API) that is called during execution of the flow.

In some implementations, flow builder customization is facilitated through an object-oriented system. Each element may correspond to an object that is generated via instantiating a class (or subclass), which may correspond to the type of element or its parent (or base) type.

Flow engine 208 may manage execution of process flows. More particularly, a user may request execution of a process flow via computing device 126 or, alternatively, another individual can request execution of the process flow on behalf of the user. Flow engine 208 can access a profile of the user from user profiles 210 to determine whether the user is authorized to execute the process flow. Upon determining that the user is authorized to execute the process flow, flow engine 208 executes the process flow.

During execution of the process flow, flow engine 208 may execute computer-readable instructions corresponding to elements of the flow. As described herein, the first or second set of computer-readable instructions associated with an element of the process flow can be executed. In some instances, the order in which elements of the flow are traversed is determined, at least in part, on user selections during execution of the flow.

Database records such as CRM records 212 may be accessed during execution of a process flow. Access of a database record can include the performance of a create, update, read, or delete database operation on the database record. Access of a database record may result in the updating of the database record or an independent log file.

During execution of the process flow, the process flow can provide data for presentation via a client device 126 and/or receive data submitted via client device 126. For example, data can be submitted and/or presented via client device 126 in relation to a screen element of the process flow. In addition, data generated by the process flow can be provided for presentation via client device 126 upon completion of execution of the process flow.

Flow builder 202 may be implemented in a variety of contexts. For example, flow builder 202 may be accessed by a software designer or engineer tasked with designing a software program or system. As another example, flow builder 202 may be accessed by an administrator or other individual to design a learning course via an online e-Learning system.

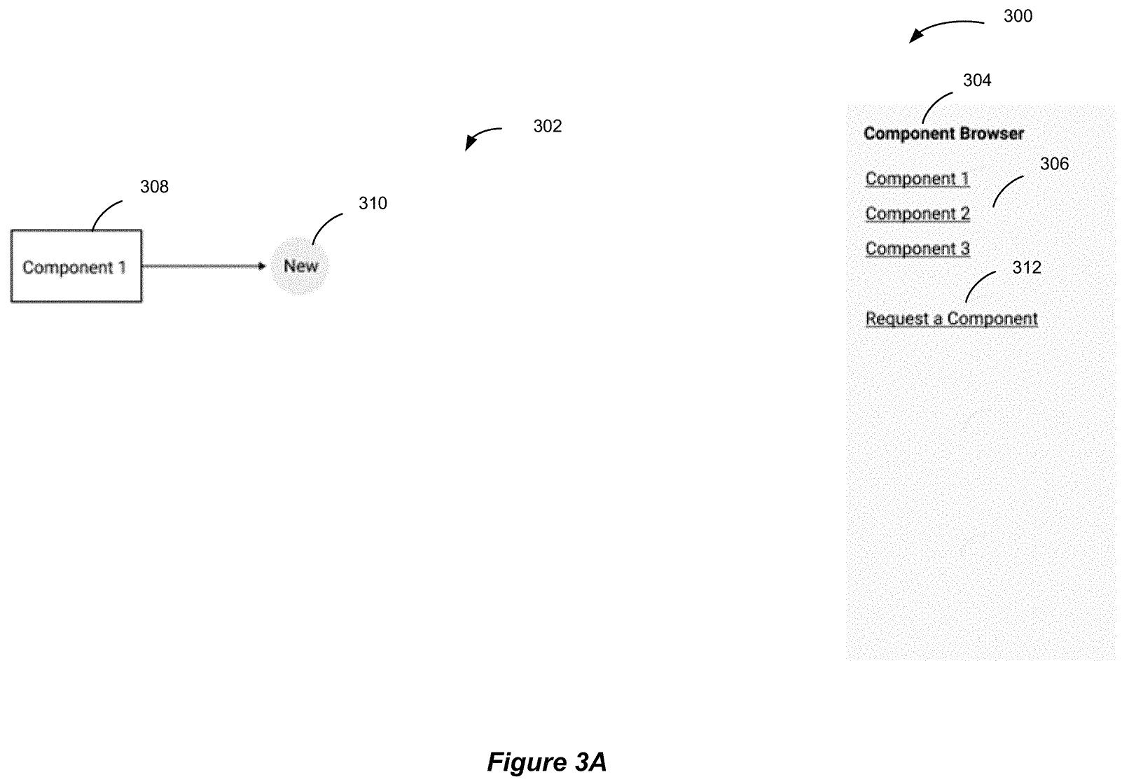

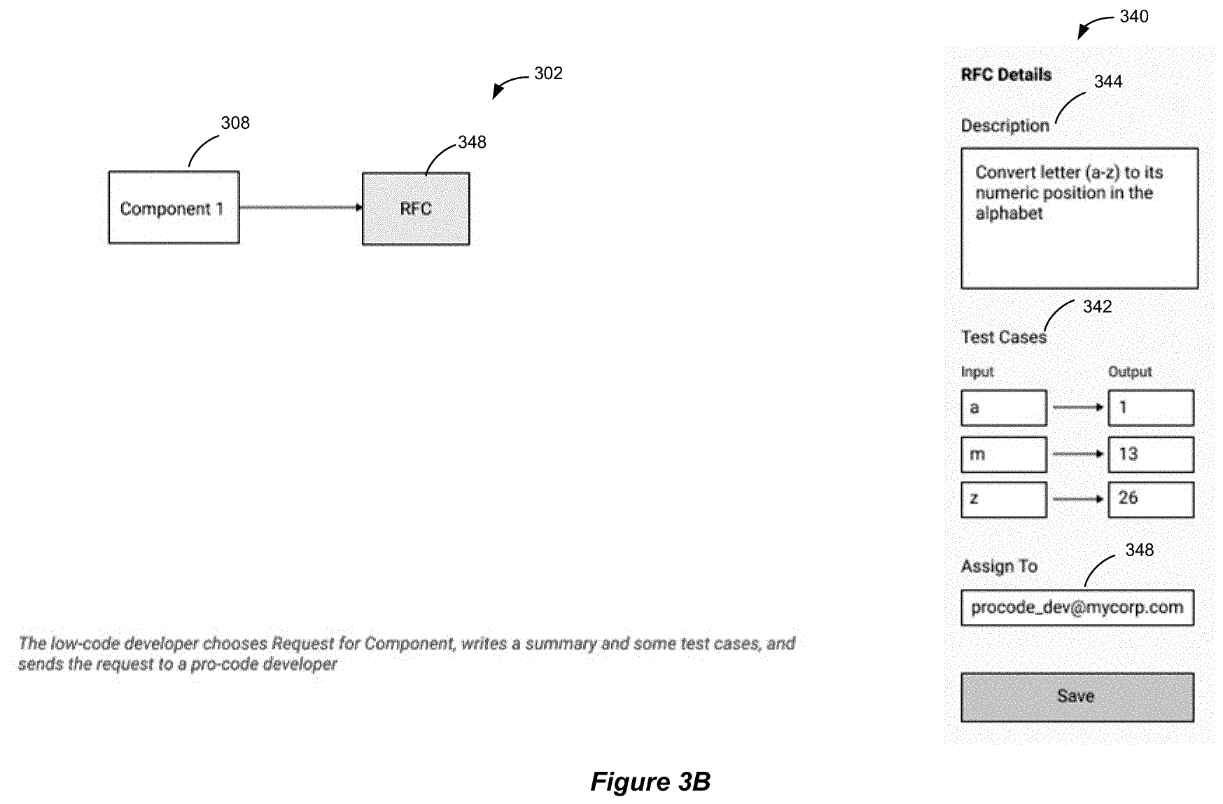

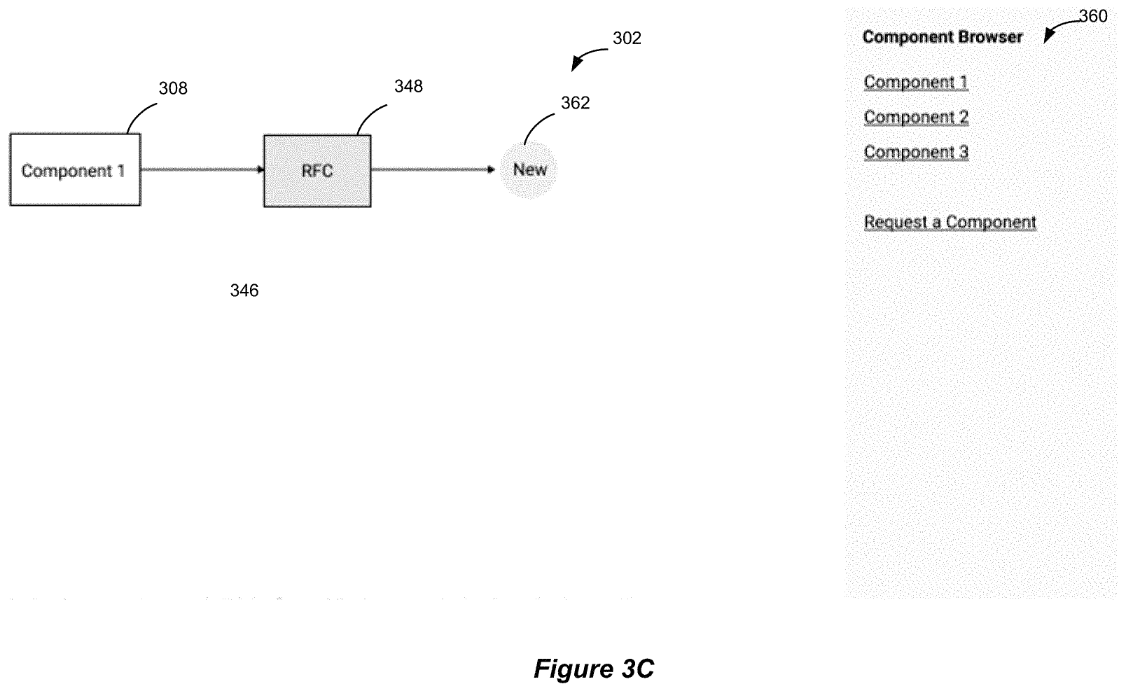

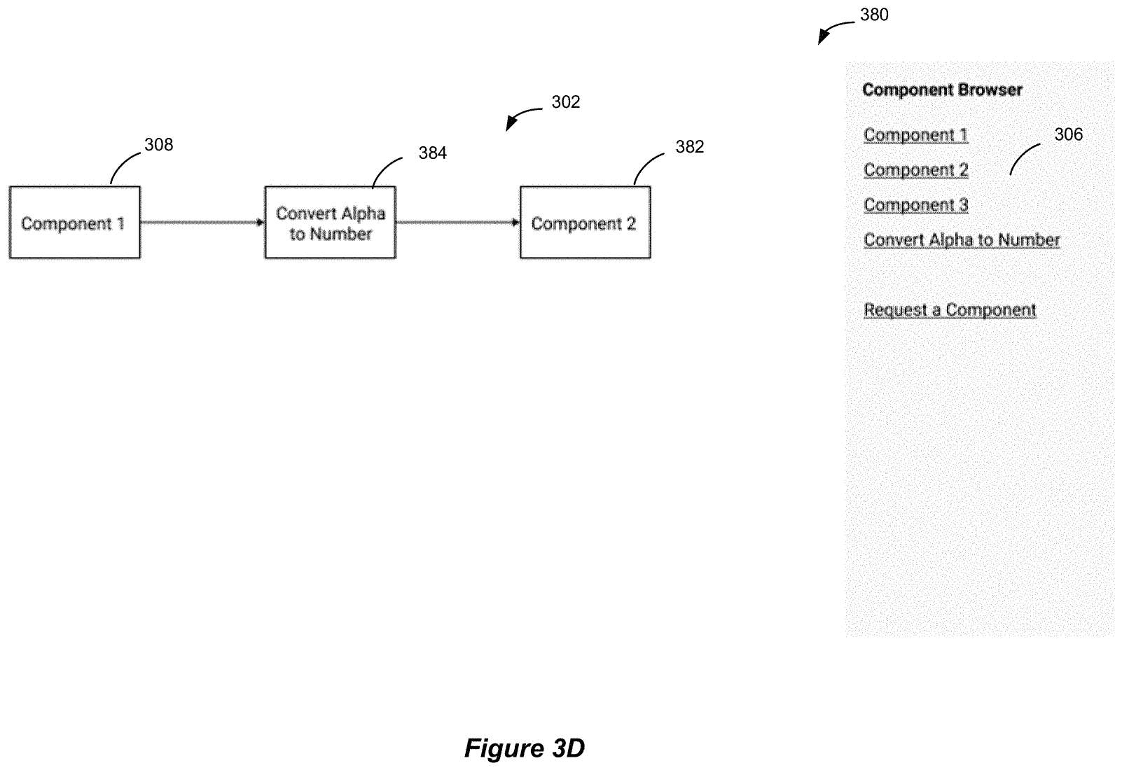

FIG. 3A shows a diagram of an example of a graphical user interface (GUI) 300 that may be presented by a flow builder, in accordance with some implementations. As shown in this example, flow builder 202 may provide, for presentation via a client device, a first graphical user interface (GUI) 300. For example, GUI 300 can include a web page. First GUI 300 can include a first segment in which a layout 302 representing a process flow can be generated and a second segment 304 (e.g., Component Browser) presenting a set of user-selectable element types 306. As shown in this example, each user-selectable element type may be represented by a corresponding icon. In addition, each user-selectable element type may be associated with a corresponding set of computer-readable instructions.

As shown in FIG. 3A, the user has selected an element type, Component 1, from second segment 304. The user then adds a representation of Component 1 to layout 302, as shown at 308. For example, the user may perform a drag-and-drop operation to position representation 308 of Component 1 at the desired location within the layout.

Unfortunately, the user finds that an element type that converts text into a pdf and subsequently stores the resulting pdf document is not available in user-selectable element types 306. The user can select a position 310 within layout 302 at which an instance of a new element type is to be added. To request computer-readable instructions that implement the new element type, the user can select a corresponding option by interacting with user interface element 312 (e.g., Request a Component). As shown in FIG. 3A, user interface element 312 may be presented within second segment 304 of GUI 300. User interface element 312 can include, for example, a button, text input box, menu option, uniform resource locator (URL), or hypertext link. By clicking on user interface element 312, the user can submit their request for computer-readable instructions.

As described above, the request can be submitted in association with a specific location 310 within layout 302 represented in the first segment of GUI 300. In other implementations, the request may be submitted independent of location 310 or layout 302.

FIG. 3B shows a diagram of an example of a second GUI 340 that may be presented by a flow builder, in accordance with some implementations. In this example, GUI 340 is presented responsive to the selection by the user of user interface element 312. GUI 340 may be presented via a segment of GUI 300 or may be presented via an independent web page.

GUI 340 is configurable to provide one or more user interface elements via which a user can submit a set of specifications in association with their request. More particularly, the set of specifications can include one or more sets of values 342, where each set of values includes a set of input values and corresponding set of output values. The sets of values 342 can operate as a set of test values for application in developing the requested code. In this example, a first set of values includes a first input value, “a”, and a corresponding first output value, “1”; a second set of values includes a second input value, “m”, and a corresponding second output value, “13” and a third set of values includes a third input value, “z”, and a corresponding third output value, “26”. In addition, the set of specifications can include a description 344 that describes the desired function to be performed by the requested instructions. In the example shown in FIG. 3B, the user has requested computer-readable instructions that convert a letter to its numerical position in the alphabet. In some implementations, the user provides or specifies a preferred icon to visually represent the new element type and/or an element type identifier associated with the new element type.

In some implementations, GUI 340 includes a user interface element 346 such as input box that enables the user to identify or otherwise indicate one or more software developers to whom the request is to be directed. In other words, the user may select the specific individuals who they would like to develop the requested computer-readable instructions. For example, the user can submit an electronic mail address of a specific software developer or group of software developers. In other implementations, the system is configurable to automatically identify software developer(s) to whom an indication of the request is submitted. For example, the system can be statically or dynamically configured with electronic mail address(es) of the software developer(s) or an associated group.

The system can transmit an indication of the request for computer-readable instructions to the software developer(s). In addition, the system can transmit information provided in the request for computer-readable instructions to the software developer(s). For example, the system can transmit the set of specifications to the software developers.

In response to the submitted request, the system can provide an icon 348 at the location of the desired element within layout 302. In some implementations, icon 348 is a placeholder that indicates that a request for computer-readable instructions has been submitted in association with the location. For example, icon 348 can denote “Request for Computer-readable instructions” or “RFC.” Icon 348 can represent a corresponding element type and/or specific element of the process flow. In some implementations, icon 348 at the user-specified location within layout 302 can be generated, selected, modified, replaced, or otherwise provided by the user or the software developer(s).

Since it can take time for the requested instructions to be developed by a software developer (or group of software developers), the system can automatically generate a first set of computer-readable instructions responsive to the request. The first set of computer-readable instructions is configurable to: maintain, for at least one set of values, a mapping between the set of input values and corresponding set of output values; and responsive to receiving the set of input values of the set of values, identify the corresponding set of output values in the mapping and provide the identified set of output values as output.

The system can store the first set of computer-readable instructions such that the first set of computer-readable instructions is associated with a representation (e.g., icon) of a corresponding element (represented at the user-selected location within layout 302), a specific element of the process flow (e.g., at the user-specified location), and/or a corresponding element type (e.g., element type identifier). As will be described in further detail below, icon 348 at the user-specified location may be replaced or modified by the system, the user, and/or software developer(s).

FIG. 3C shows a diagram of another example of a GUI 360 that may be presented by a flow builder, in accordance with some implementations. The user can continue to add additional elements to the process flow by updating layout 302. As shown at 362, the user can add additional icons representing elements at various locations within layout 302 regardless of whether the requested instructions have been provided by software developers or pre-existing instructions that satisfy the specifications have been identified by the system.

Icon 348 may be modified or replaced by the user, the software developer(s), or the system. For example, icon 348 can be modified or replaced after the request for computer-readable instructions is submitted, after the system generates the first set of computer-readable instructions, and/or after the software developer(s) generate and provide the requested instructions. As will be described in further detail below, icon 348 can also be replaced in the event that the system identifies, within storage medium(s), computer-readable instructions associated with an element type that performs the desired function.

FIG. 3D shows a diagram of another example of a GUI 380 that may be presented by a flow builder, in accordance with some implementations. In this example, the user has selected an element type, Component 2, from user-selectable element types 306 of second segment 304. The user then adds a representation of Component 2 to layout 302, as shown at 382. For example, the user may perform a drag-and-drop operation to position representation 382 of Component 1 at the desired location within the layout.

Icon 348 representing the element at the user-selected location may be replaced or modified, as shown at 384. More particularly, icon 348 can be modified or replaced as shown at 384 after the first set of computer-readable instructions has been generated or, alternatively, after the requested instructions have been obtained from software developer(s) or preexisting code that operates according to the user-provided specifications has been identified by the system.

During execution of the process flow, the first set of computer-readable instructions associated with the element may receive or otherwise obtain input from Component 1 308 and output corresponding output value(s) to component 382. The first set of computer-readable instructions may subsequently be replaced by a second set of computer-readable instructions, as described in further detail below.

The system can obtain a second set of computer-readable instructions that performs the desired function. For example, the system can identify, within storage medium(s) a second set of computer-readable instructions that performs the desired function. As another example, the system can receive a second set of computer-readable instructions from software developer(s).

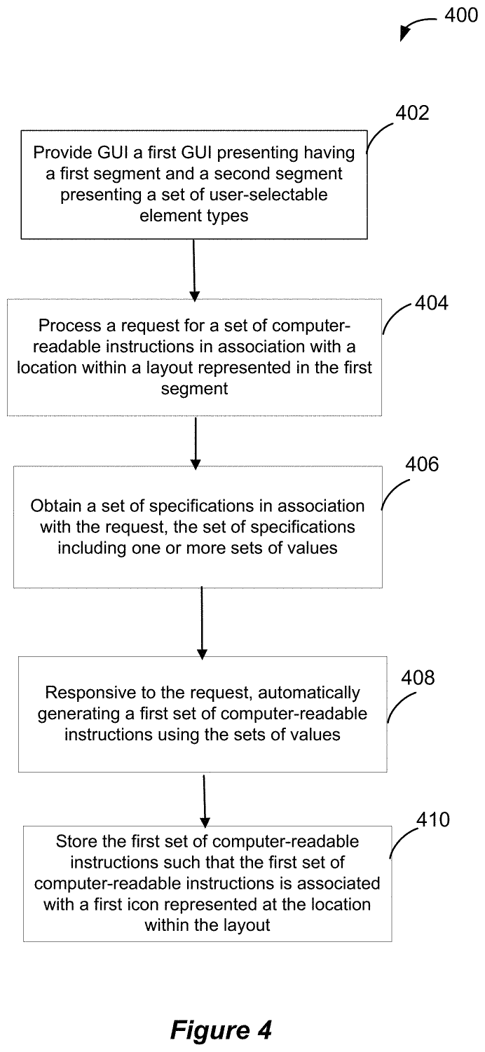

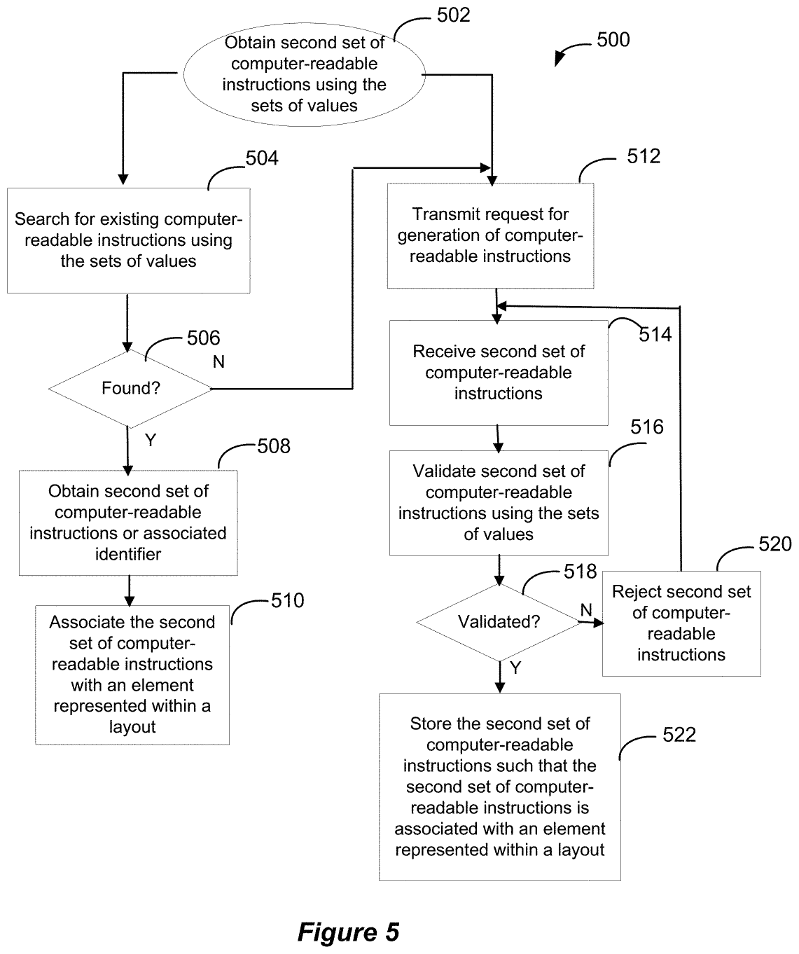

A general method of implementing a flow builder including generating the first set of computer-readable instructions will be described below with reference to FIG. 4. A specific method of obtaining the second set of computer-readable instructions will be described in further detail with reference to FIG. 5.

FIG. 4 shows a process flow diagram 400 illustrating a method of a implementing a flow builder, in accordance with various implementations. As shown at 402, the system provides, for presentation via a client device, a first graphical user interface (GUI) having a first segment and a second segment presenting a set of user-selectable element types. Each user-selectable element type of the set of user-selectable element types may be associated with an icon and a corresponding set of computer-readable instructions. A user may select one of the element types and perform a drag-and-drop operation to position the corresponding icon within the layout at a desired location.

In the event that a desired element type does not appear to be available for selection, the user can submit a request for a set of computer-readable instructions in association with a location within a layout represented in the first segment of the GUI, as described above. The request may be transmitted to the system for processing.

In some implementations, a first icon indicating that a request for a set of computer-readable instructions has been submitted in association with the element of the process flow is represented at the location within the layout. This enables a user to easily determine that a request for a set of computer-readable instructions has submitted in association with the location within the layout.

The system processes the request, received from a client device, as shown at 404. In response to the request, the system may provide a second GUI that enables the user to provide a set of specifications in association with the request.

The system obtains, from the client device, a set of specifications in association with the request at 406. The set of specifications can include one or more sets of values, where each set of values includes or otherwise indicates a set of input values and corresponding set of output values.

Responsive to the request, the system can automatically generate a first set of computer-readable instructions at 408. The first set of computer-readable instructions is configurable to: maintain, for at least one set of values, a mapping between the set of input values and corresponding set of output values. In addition, the first set of computer-readable instructions is configurable to, responsive to receiving the set of input values of the set of values, identify the corresponding set of output values in the mapping and provide the identified set of output values. For example, the identified set of output values can be provided via an API as input to another element of the process flow.

The system may then store the first set of computer-readable instructions at 410 such that the first set of computer-readable instructions is associated with a first icon represented at the location within the layout, where the first icon represents an element of the process flow.

As described above, the first set of computer-readable instructions can implement a mapping between set(s) of values provided by the user. In addition, the system can obtain a second set of computer-readable instructions that performs the desired function rather than simply implements a mapping. A user can continue to build their layout and the corresponding process flow can be executed during the interim period between generation of the first set of computer-readable instructions and obtaining the second set of computer-readable instructions. During execution of the process flow during the interim period, the first set of computer-readable instructions can be executed, enabling the user to continue to build and test the process flow.

Upon obtaining a second set of computer-readable instructions that performs the desired function, the system can associate the second set of computer-readable instructions with an icon represented at the desired location. For example, the system can replace the first set of computer-readable instructions with the second set of computer-readable instructions. A method of obtaining the second set of computer-readable instructions will be described in further detail below with reference to FIG. 5.

FIG. 5 shows a process flow diagram 500 illustrating a method of obtaining a second set of computer-readable instructions associated with an element of a process flow, in accordance with some implementations. The second set of computer-readable instructions can be obtained subsequent to the automated generation of the first set of computer-readable instructions or in parallel with the automated generation of the first set of computer-readable instructions.

As shown at 502, process flow diagram 500 includes two different branches illustrating two different processes that the system can execute to obtain the second set of computer-readable instructions. In some implementations, the two processes can operate as alternatives such that the system executes a single branch to obtain the second set of computer-readable instructions. In other implementations, the two processes can both be executed to obtain the second set of computer-readable instructions.

As shown within the first branch of process flow diagram 500, the system can obtain a pre-existing set of computer-readable instructions that performs the desired function. More particularly, the system can perform a search at 504 in local and/or remote data sources using the set of values and/or description to determine whether a set of computer-readable instructions that performs the desired function is already stored in computer readable medium(s) of the system or is otherwise accessible to the system. For example, the system can search a database or directory, as described herein.

To identify the second set of computer-readable instructions, the system may validate the second set of computer-readable instructions using the set of specifications to verify that it performs the desired function. Validating the second set of computer-readable instructions can include verifying that the second set of computer-readable instructions, during execution of the second set of computer-readable instructions, for each set of values, generates the set of output values responsive to receiving the corresponding set of input values;

As another example, the system can identify the second set of computer-readable instructions or an associated with an element type using information stored in association with the second set of computer-readable instructions. Such information can include, but is not limited to, a description associated with the second set of computer-readable instructions, an identifier of the corresponding element type, or information stored in association with the relevant icon such as the identifier of the icon.

If the system determines that it has identified a second set of computer-readable instructions that operates according to the set of specifications provided by the user in association with their request at 506, the system can obtain the second set of computer-readable instructions (e.g., code module(s) or API) or an associated identifier at 508. The system can associate the second set of computer-readable instructions with a specific element represented at the user-selected location within the layout, an element type associated with the specific element, and/or a corresponding icon that may be represented within the layout at 510. For example, the system can store the second set of computer-readable instructions in association with the specific element, the element type associated with the specific element, and/or a corresponding icon such as that shown at 382 of FIG. 3D.

In some implementations, the icon represented within the layout is the same as that associated with a particular element type corresponding to the identified second set of computer-readable instructions. In other implementations, the icon represented within the layout can be different from that associated with the particular element type. Thus, the second set of computer-readable instructions can be associated with one or more icons and/or one or more element types.

As shown within the second branch of process flow diagram 500, the system can obtain a second set of computer-readable instructions that performs the desired function from software developer(s). In some implementations, the system proceeds to obtain the second set of computer-readable instructions via the second branch of process flow 500 responsive to determining at 506 that it was unable to identify an existing set of computer-readable instructions that operates according to the user-submitted request and associated set of specifications (e.g., set(s) of values). Alternatively, if the system is able to identify an existing set of computer-readable instructions that operates according to the user-submitted request, the system may not proceed with the second branch of process flow diagram 500. In other implementations, the system proceeds with the second branch of process flow diagram 500 without executing the first branch of process flow diagram 500.

The system can transmit a request for computer-readable instructions to one or more recipients (e.g., software developers) at 512. More particularly, the transmitted request can include instructions to obtain a set of computer-readable instructions according to the user-submitted request. For example, the transmitted request can include instructions to generate a set of computer-readable instructions or otherwise identify a set of computer-readable instructions that operates according to the user-submitted request and associated specifications. The transmitted request can include an indication of the user-submitted request and/or information (e.g., specifications) submitted by the user in conjunction with their submitted request. For example, the system can automatically transmit a request for generation of computer-readable instructions to the recipients via one or more electronic mail addresses.

The system can then receive a second set of computer-readable instructions from at least one of the recipients at 514. For example, the second set of computer-readable instructions can include source code and/or a corresponding API. The second set of computer-readable instructions can be submitted, for example, via a GUI or can be uploaded to a particular folder or directory. The system can then process the second set of computer-readable instructions.

In some implementations, processing the second set of computer-readable instructions includes validating the second set of computer-readable instructions using the set of specifications (e.g., set(s) of values) at 516. More particularly, the system can verify that the second set of computer-readable instructions, during execution of the second set of computer-readable instructions, for each set of values, generates the set of output values responsive to receiving the corresponding set of input values.

If the system determines that it cannot validate the second set of computer-readable instructions at 518, the system can reject the second set of computer-readable instructions at 520. For example, the system can transmit a message to the software developer(s) indicating that the second set of computer-readable instructions is rejected by the system. If the system determines that the second set of computer-readable instructions is validated at 518, the system can store the second set of computer-readable instructions at 522.

The generated second set of computer-readable instructions can be stored such that the second set of computer-readable instructions is associated with a specific element represented at the user-specified location within the layout, an element type (e.g., specified in the set of specifications or by the software developer(s)), and/or a corresponding icon (e.g., as specified in the set of specifications or by the software developer(s)).

In some implementations, the second set of computer-readable instructions received at 514 is pre-existing code that has been identified by the recipient(s) of the request (rather than newly generated). For example, the pre-existing code may be identified in another part of the system or in relation to another process flow type. A second set of computer-readable instructions identified by the recipient(s) can be stored such that the second set of computer-readable instructions is associated with a specific element represented at the user-specified location within the layout, an element type (e.g., specified in the set of specifications or by the software developer(s)), and/or a corresponding icon (e.g., as specified in the set of specifications or by the software developer(s)). Alternatively, the second set of computer-readable instructions identified by the recipient(s) can be stored such that the corresponding element type and/or icon are associated with the specific element represented at the user-specified location within the layout. In other words, the icon and/or element type of the pre-existing code may be applied to the instance within the layout.

The system can store the second set of computer-readable instructions such that the second set of computer-readable instructions replaces the first set of computer-readable instructions. In addition, an icon representing the corresponding element type can be added to the component browser for a process flow type associated with the layout.

The process flow represented by the layout may subsequently be executed. During execution of the process flow, the second set of computer-readable instructions is executed in relation to the process flow element rather than the first set of computer-readable instructions.

The disclosed implementations enable a user of a visual process flow design tool to request creation of a process flow component (e.g., element type) that is not available to the user for selection via the design tool. By automatically generating a first set of computer-readable instructions for the requested component, this enables the user to continue building a layout and performing testing of the corresponding process flow without delay. When a second set of computer-readable instructions that performs the desired function is generated by software developer(s) or otherwise identified, the first set of computer-readable instructions can be replaced with the second set of computer-readable instructions. Therefore, the disclosed implementations enable components to be requested and generated in parallel with the building of layouts and associated process flow testing.

Some but not all of the techniques described or referenced herein are implemented using or in conjunction with a database system. Salesforce.com, inc, is a provider of customer relationship management (CRM) services and other database management services, which can be accessed and used in conjunction with the techniques disclosed herein in some implementations. In some but not all implementations, services can be provided in a cloud computing environment, for example, in the context of a multi-tenant database system. Thus, some of the disclosed techniques can be implemented without having to install software locally, that is, on computing devices of users interacting with services available through the cloud. Some of the disclosed techniques can be implemented via an application installed on computing devices of users.

Information stored in a database record can include various types of data including character-based data, audio data, image data, animated images, and/or video data. A database record can store one or more files, which can include text, presentations, documents, multimedia files, and the like. Data retrieved from a database can be presented via a computing device. For example, visual data can be displayed in a graphical user interface (GUI) on a display device such as the display of the computing device. In some but not all implementations, the disclosed methods, apparatus, systems, and computer program products may be configured or designed for use in a multi-tenant database environment.

The term “multi-tenant database system” generally refers to those systems in which various elements of hardware and/or software of a database system may be shared by one or more customers. For example, a given application server may simultaneously process requests for a great number of customers, and a given database table may store rows of data such as feed items for a potentially much greater number of customers.

An example of a “user profile” or “user's profile” is a database object or set of objects configured to store and maintain data about a given user of a social networking system and/or database system. The data can include general information, such as name, title, phone number, a photo, a biographical summary, and a status, e.g., text describing what the user is currently doing. Where there are multiple tenants, a user is typically associated with a particular tenant. For example, a user could be a salesperson of a company, which is a tenant of the database system that provides a database service.

The term “record” generally refers to a data entity having fields with values and stored in database system. An example of a record is an instance of a data object created by a user of the database service, for example, in the form of a CRM record about a particular (actual or potential) business relationship or project. The record can have a data structure defined by the database service (a standard object) or defined by a user (custom object). For example, a record can be for a business partner or potential business partner (e.g., a client, vendor, distributor, etc.) of the user, and can include information describing an entire company, subsidiaries, or contacts at the company. As another example, a record can be a project that the user is working on, such as an opportunity (e.g., a possible sale) with an existing partner, or a project that the user is trying to get. In one implementation of a multi-tenant database system, each record for the tenants has a unique identifier stored in a common table. A record has data fields that are defined by the structure of the object (e.g., fields of certain data types and purposes). A record can also have custom fields defined by a user. A field can be another record or include links thereto, thereby providing a parent-child relationship between the records.

Some non-limiting examples of systems, apparatus, and methods are described below for implementing database systems and enterprise level social networking systems in conjunction with the disclosed techniques. Such implementations can provide more efficient use of a database system. For instance, a user of a database system may not easily know when important information in the database has changed, e.g., about a project or client. Such implementations can provide feed tracked updates about such changes and other events, thereby keeping users informed.

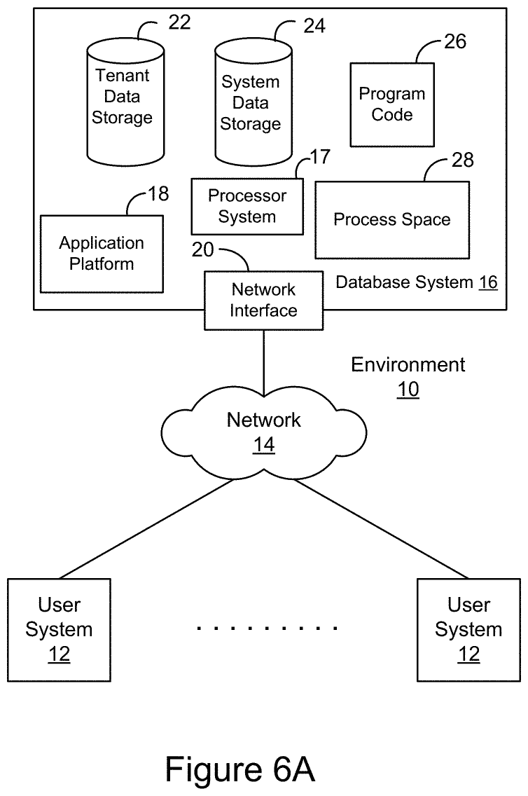

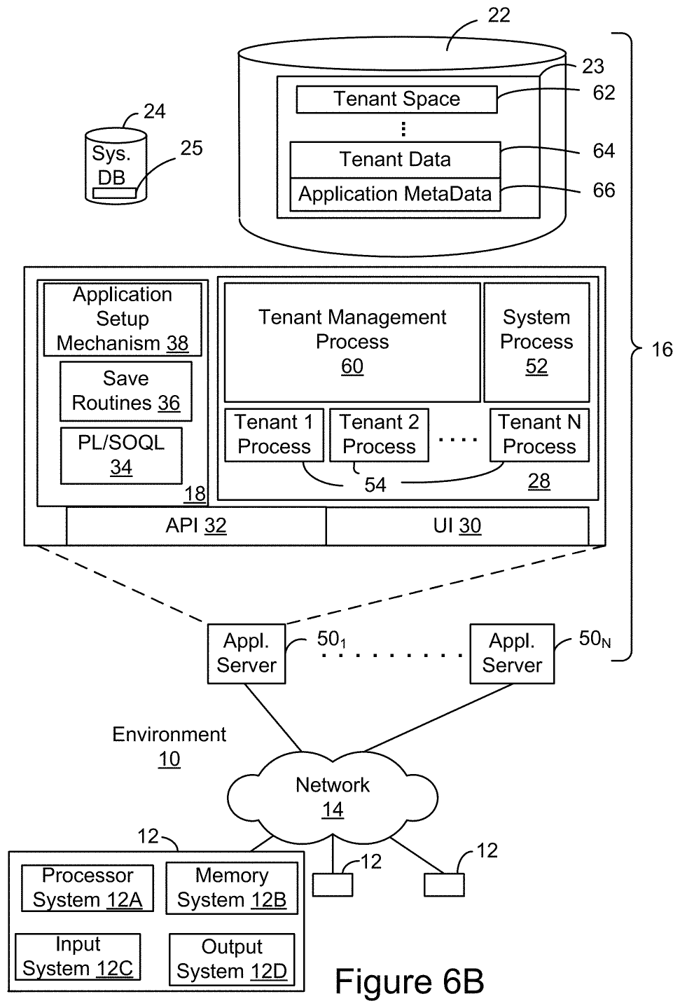

FIG. 6A shows a block diagram of an example of an environment 10 in which an on-demand database service exists and can be used in accordance with some implementations. Environment 10 may include user systems 12, network 14, database system 16, processor system 17, application platform 18, network interface 20, tenant data storage 22, system data storage 24, program code 26, and process space 28. In other implementations, environment 10 may not have all of these components and/or may have other components instead of, or in addition to, those listed above.

A user system 12 may be implemented as any computing device(s) or other data processing apparatus such as a machine or system used by a user to access a database system 16. For example, any of user systems 12 can be a handheld and/or portable computing device such as a mobile phone, a smartphone, a laptop computer, or a tablet. Other examples of a user system include computing devices such as a work station and/or a network of computing devices. As illustrated in FIG. 6A (and in more detail in FIG. 6B) user systems 12 might interact via a network 14 with an on-demand database service, which is implemented in the example of FIG. 6A as database system 16.

An on-demand database service, implemented using system 16 by way of example, is a service that is made available to users who do not need to necessarily be concerned with building and/or maintaining the database system. Instead, the database system may be available for their use when the users need the database system, i.e., on the demand of the users. Some on-demand database services may store information from one or more tenants into tables of a common database image to form a multi-tenant database system (MTS). A database image may include one or more database objects. A relational database management system (RDBMS) or the equivalent may execute storage and retrieval of information against the database object(s). Application platform 18 may be a framework that allows the applications of system 16 to run, such as the hardware and/or software, e.g., the operating system. In some implementations, application platform 18 enables creation, managing and executing one or more applications developed by the provider of the on-demand database service, users accessing the on-demand database service via user systems 12, or third party application developers accessing the on-demand database service via user systems 12.

The users of user systems 12 may differ in their respective capacities, and the capacity of a particular user system 12 might be entirely determined by permissions (permission levels) for the current user. For example, when a salesperson is using a particular user system 12 to interact with system 16, the user system has the capacities allotted to that salesperson. However, while an administrator is using that user system to interact with system 16, that user system has the capacities allotted to that administrator. In systems with a hierarchical role model, users at one permission level may have access to applications, data, and database information accessible by a lower permission level user, but may not have access to certain applications, database information, and data accessible by a user at a higher permission level. Thus, different users will have different capabilities with regard to accessing and modifying application and database information, depending on a user's security or permission level, also called authorization.

Network 14 is any network or combination of networks of devices that communicate with one another. For example, network 14 can be any one or any combination of a LAN (local area network), WAN (wide area network), telephone network, wireless network, point-to-point network, star network, token ring network, hub network, or other appropriate configuration. Network 14 can include a TCP/IP (Transfer Control Protocol and Internet Protocol) network, such as the global internetwork of networks often referred to as the Internet. The Internet will be used in many of the examples herein. However, it should be understood that the networks that the present implementations might use are not so limited.

User systems 12 might communicate with system 16 using TCP/IP and, at a higher network level, use other common Internet protocols to communicate, such as HTTP, FTP, AFS, WAP, etc. In an example where HTTP is used, user system 12 might include an HTTP client commonly referred to as a “browser” for sending and receiving HTTP signals to and from an HTTP server at system 16. Such an HTTP server might be implemented as the sole network interface 20 between system 16 and network 14, but other techniques might be used as well or instead. In some implementations, the network interface 20 between system 16 and network 14 includes load sharing functionality, such as round-robin HTTP request distributors to balance loads and distribute incoming HTTP requests evenly over a plurality of servers. At least for users accessing system 16, each of the plurality of servers has access to the MTS' data; however, other alternative configurations may be used instead.

In one implementation, system 16, shown in FIG. 6A, implements a web-based CRM system. For example, in one implementation, system 16 includes application servers configured to implement and execute CRM software applications as well as provide related data, code, forms, web pages and other information to and from user systems 12 and to store to, and retrieve from, a database system related data, objects, and Webpage content. With a multi-tenant system, data for multiple tenants may be stored in the same physical database object in tenant data storage 22, however, tenant data typically is arranged in the storage medium(s) of tenant data storage 22 so that data of one tenant is kept logically separate from that of other tenants so that one tenant does not have access to another tenant's data, unless such data is expressly shared. In certain implementations, system 16 implements applications other than, or in addition to, a CRM application. For example, system 16 may provide tenant access to multiple hosted (standard and custom) applications, including a CRM application. User (or third party developer) applications, which may or may not include CRM, may be supported by the application platform 18, which manages creation, storage of the applications into one or more database objects and executing of the applications in a virtual machine in the process space of the system 16.

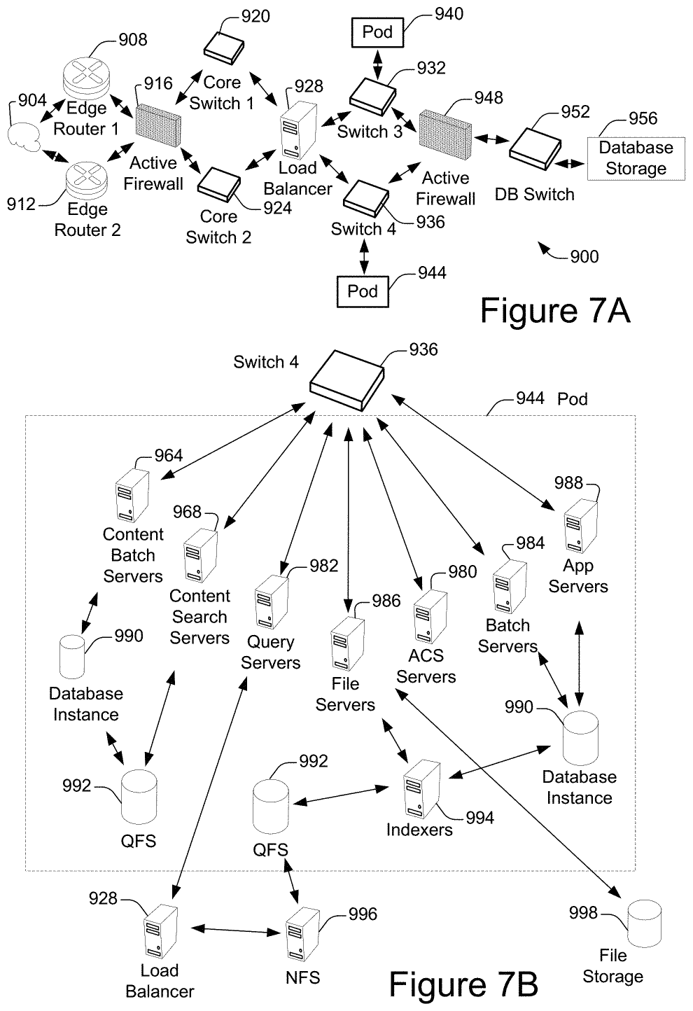

One arrangement for elements of system 16 is shown in FIGS. 7A and 7B, including a network interface 20, application platform 18, tenant data storage 22 for tenant data 23, system data storage 24 for system data 25 accessible to system 16 and possibly multiple tenants, program code 26 for implementing various functions of system 16, and a process space 28 for executing MTS system processes and tenant-specific processes, such as running applications as part of an application hosting service. Additional processes that may execute on system 16 include database indexing processes.

Several elements in the system shown in FIG. 6A include conventional, well-known elements that are explained only briefly here. For example, each user system 12 could include a desktop personal computer, workstation, laptop, PDA, cell phone, or any wireless access protocol (WAP) enabled device or any other computing device capable of interfacing directly or indirectly to the Internet or other network connection. The term “computing device” is also referred to herein simply as a “computer”. User system 12 typically runs an HTTP client, e.g., a browsing program, such as Microsoft's Internet Explorer browser, Netscape's Navigator browser, Opera's browser, or a WAP-enabled browser in the case of a cell phone, PDA or other wireless device, or the like, allowing a user (e.g., subscriber of the multi-tenant database system) of user system 12 to access, process and view information, pages and applications available to it from system 16 over network 14. Each user system 12 also typically includes one or more user input devices, such as a keyboard, a mouse, trackball, touch pad, touch screen, pen or the like, for interacting with a GUI provided by the browser on a display (e.g., a monitor screen, LCD display, OLED display, etc.) of the computing device in conjunction with pages, forms, applications and other information provided by system 16 or other systems or servers. Thus, “display device” as used herein can refer to a display of a computer system such as a monitor or touch-screen display, and can refer to any computing device having display capabilities such as a desktop computer, laptop, tablet, smartphone, a television set-top box, or wearable device such Google Glass® or other human body-mounted display apparatus. For example, the display device can be used to access data and applications hosted by system 16, and to perform searches on stored data, and otherwise allow a user to interact with various GUI pages that may be presented to a user. As discussed above, implementations are suitable for use with the Internet, although other networks can be used instead of or in addition to the Internet, such as an intranet, an extranet, a virtual private network (VPN), a non-TCP/IP based network, any LAN or WAN or the like.

According to one implementation, each user system 12 and all of its components are operator configurable using applications, such as a browser, including computer code run using a central processing unit such as an Intel Pentium® processor or the like. Similarly, system 16 (and additional instances of an MTS, where more than one is present) and all of its components might be operator configurable using application(s) including computer code to run using processor system 17, which may be implemented to include a central processing unit, which may include an Intel Pentium) processor or the like, and/or multiple processor units. Non-transitory computer-readable media can have instructions stored thereon/in, that can be executed by or used to program a computing device to perform any of the methods of the implementations described herein. Computer program code 26 implementing instructions for operating and configuring system 16 to intercommunicate and to process web pages, applications and other data and media content as described herein is preferably downloadable and stored on a hard disk, but the entire program code, or portions thereof, may also be stored in any other volatile or non-volatile memory medium or device as is well known, such as a ROM or RAM, or provided on any media capable of storing program code, such as any type of rotating media including floppy disks, optical discs, digital versatile disk (DVD), compact disk (CD), microdrive, and magneto-optical disks, and magnetic or optical cards, nanosystems (including molecular memory ICs), or any other type of computer-readable medium or device suitable for storing instructions and/or data. Additionally, the entire program code, or portions thereof, may be transmitted and downloaded from a software source over a transmission medium, e.g., over the Internet, or from another server, as is well known, or transmitted over any other conventional network connection as is well known (e.g., extranet, VPN, LAN, etc.) using any communication medium and protocols (e.g., TCP/IP, HTTP, HTTPS, Ethernet, etc.) as are well known. It will also be appreciated that computer code for the disclosed implementations can be realized in any programming language that can be executed on a client system and/or server or server system such as, for example, C, C++, HTML, any other markup language, Java™, JavaScript, ActiveX, any other scripting language, such as VBScript, and many other programming languages as are well known may be used. (Java™ is a trademark of Sun Microsystems, Inc.).

According to some implementations, each system 16 is configured to provide web pages, forms, applications, data and media content to user (client) systems 12 to support the access by user systems 12 as tenants of system 16. As such, system 16 provides security mechanisms to keep each tenant's data separate unless the data is shared. If more than one MTS is used, they may be located in close proximity to one another (e.g., in a server farm located in a single building or campus), or they may be distributed at locations remote from one another (e.g., one or more servers located in city A and one or more servers located in city B). As used herein, each MTS could include one or more logically and/or physically connected servers distributed locally or across one or more geographic locations. Additionally, the term “server” is meant to refer to one type of computing device such as a system including processing hardware and process space(s), an associated storage medium such as a memory device or database, and, in some instances, a database application (e.g., OODBMS or RDBMS) as is well known in the art. It should also be understood that “server system” and “server” are often used interchangeably herein. Similarly, the database objects described herein can be implemented as single databases, a distributed database, a collection of distributed databases, a database with redundant online or offline backups or other redundancies, etc., and might include a distributed database or storage network and associated processing intelligence.

FIG. 6B shows a block diagram of an example of some implementations of elements of FIG. 6A and various possible interconnections between these elements. That is, FIG. 6B also illustrates environment 10. However, in FIG. 6B elements of system 16 and various interconnections in some implementations are further illustrated. FIG. 6B shows that user system 12 may include processor system 12A, memory system 12B, input system 12C, and output system 12D. FIG. 6B shows network 14 and system 16. FIG. 6B also shows that system 16 may include tenant data storage 22, tenant data 23, system data storage 24, system data 25, User Interface (UI) 30, Application Program Interface (API) 32, PL/SOQL 34, save routines 36, application setup mechanism 38, application servers 50₁-50_{N}, system process space 52, tenant process spaces 54, tenant management process space 60, tenant storage space 62, user storage 64, and application metadata 66. In other implementations, environment 10 may not have the same elements as those listed above and/or may have other elements instead of, or in addition to, those listed above.

User system 12, network 14, system 16, tenant data storage 22, and system data storage 24 were discussed above in FIG. 6A. Regarding user system 12, processor system 12A may be any combination of one or more processors. Memory system 12B may be any combination of one or more memory devices, short term, and/or long term memory. Input system 12C may be any combination of input devices, such as one or more keyboards, mice, trackballs, scanners, cameras, and/or interfaces to networks. Output system 12D may be any combination of output devices, such as one or more monitors, printers, and/or interfaces to networks. As shown by FIG. 6B, system 16 may include a network interface 20 (of FIG. 6A) implemented as a set of application servers 50, an application platform 18, tenant data storage 22, and system data storage 24. Also shown is system process space 52, including individual tenant process spaces 54 and a tenant management process space 60. Each application server 50 may be configured to communicate with tenant data storage 22 and the tenant data 23 therein, and system data storage 24 and the system data 25 therein to serve requests of user systems 12. The tenant data 23 might be divided into individual tenant storage spaces 62, which can be either a physical arrangement and/or a logical arrangement of data. Within each tenant storage space 62, user storage 64 and application metadata 66 might be similarly allocated for each user. For example, a copy of a user's most recently used (MRU) items might be stored to user storage 64. Similarly, a copy of MRU items for an entire organization that is a tenant might be stored to tenant storage space 62. A UI 30 provides a user interface and an API 32 provides an application programmer interface to system 16 resident processes to users and/or developers at user systems 12. The tenant data and the system data may be stored in various databases, such as one or more Oracle® databases.

Application platform 18 includes an application setup mechanism 38 that supports application developers' creation and management of applications, which may be saved as metadata into tenant data storage 22 by save routines 36 for execution by subscribers as one or more tenant process spaces 54 managed by tenant management process 60 for example. Invocations to such applications may be coded using PL/SOQL 34 that provides a programming language style interface extension to API 32. A detailed description of some PL/SOQL language implementations is discussed in commonly assigned U.S. Pat. No. 7,730,478, titled METHOD AND SYSTEM FOR ALLOWING ACCESS TO DEVELOPED APPLICATIONS VIA A MULTI-TENANT ON-DEMAND DATABASE SERVICE, by Craig Weissman, issued on Jun. 1, 2010, and hereby incorporated by reference in its entirety and for all purposes. Invocations to applications may be detected by one or more system processes, which manage retrieving application metadata 66 for the subscriber making the invocation and executing the metadata as an application in a virtual machine.

Each application server 50 may be communicably coupled to database systems, e.g., having access to system data 25 and tenant data 23, via a different network connection. For example, one application server 50₁ might be coupled via the network 14 (e.g., the Internet), another application server 50_{N-1} might be coupled via a direct network link, and another application server 50_{N} might be coupled by yet a different network connection. Transfer Control Protocol and Internet Protocol (TCP/IP) are typical protocols for communicating between application servers 50 and the database system. However, it will be apparent to one skilled in the art that other transport protocols may be used to optimize the system depending on the network interconnect used.

In certain implementations, each application server 50 is configured to handle requests for any user associated with any organization that is a tenant. Because it is desirable to be able to add and remove application servers from the server pool at any time for any reason, there is preferably no server affinity for a user and/or organization to a specific application server 50. In one implementation, therefore, an interface system implementing a load balancing function (e.g., an F5 Big-IP load balancer) is communicably coupled between the application servers 50 and the user systems 12 to distribute requests to the application servers 50. In one implementation, the load balancer uses a least connections algorithm to route user requests to the application servers 50. Other examples of load balancing algorithms, such as round robin and observed response time, also can be used. For example, in certain implementations, three consecutive requests from the same user could hit three different application servers 50, and three requests from different users could hit the same application server 50. In this manner, by way of example, system 16 is multi-tenant, wherein system 16 handles storage of, and access to, different objects, data and applications across disparate users and organizations.

As an example of storage, one tenant might be a company that employs a sales force where each salesperson uses system 16 to manage their sales process. Thus, a user might maintain contact data, leads data, customer follow-up data, performance data, goals and progress data, etc., all applicable to that user's personal sales process (e.g., in tenant data storage 22). In an example of a MTS arrangement, since all of the data and the applications to access, view, modify, report, transmit, calculate, etc., can be maintained and accessed by a user system having nothing more than network access, the user can manage his or her sales efforts and cycles from any of many different user systems. For example, if a salesperson is visiting a customer and the customer has Internet access in their lobby, the salesperson can obtain critical updates as to that customer while waiting for the customer to arrive in the lobby.

While each user's data might be separate from other users' data regardless of the employers of each user, some data might be organization-wide data shared or accessible by a plurality of users or all of the users for a given organization that is a tenant. Thus, there might be some data structures managed by system 16 that are allocated at the tenant level while other data structures might be managed at the user level. Because an MTS might support multiple tenants including possible competitors, the MTS should have security protocols that keep data, applications, and application use separate. Also, because many tenants may opt for access to an MTS rather than maintain their own system, redundancy, up-time, and backup are additional functions that may be implemented in the MTS. In addition to user-specific data and tenant-specific data, system 16 might also maintain system level data usable by multiple tenants or other data. Such system level data might include industry reports, news, postings, and the like that are sharable among tenants.

In certain implementations, user systems 12 (which may be client systems) communicate with application servers 50 to request and update system-level and tenant-level data from system 16 that may involve sending one or more queries to tenant data storage 22 and/or system data storage 24. System 16 (e.g., an application server 50 in system 16) automatically generates one or more SQL statements (e.g., one or more SQL queries) that are designed to access the desired information. System data storage 24 may generate query plans to access the requested data from the database.

Each database can generally be viewed as a collection of objects, such as a set of logical tables, containing data fitted into predefined categories. A “table” is one representation of a data object, and may be used herein to simplify the conceptual description of objects and custom objects according to some implementations. It should be understood that “table” and “object” may be used interchangeably herein. Each table generally contains one or more data categories logically arranged as columns or fields in a viewable schema. Each row or record of a table contains an instance of data for each category defined by the fields. For example, a CRM database may include a table that describes a customer with fields for basic contact information such as name, address, phone number, fax number, etc. Another table might describe a purchase order, including fields for information such as customer, product, sale price, date, etc. In some multi-tenant database systems, standard entity tables might be provided for use by all tenants. For CRM database applications, such standard entities might include tables for case, account, contact, lead, and opportunity data objects, each containing pre-defined fields. It should be understood that the word “entity” may also be used interchangeably herein with “object” and “table”.

In some multi-tenant database systems, tenants may be allowed to create and store custom objects, or they may be allowed to customize standard entities or objects, for example by creating custom fields for standard objects, including custom index fields. Commonly assigned U.S. Pat. No. 7,779,039, titled CUSTOM ENTITIES AND FIELDS IN A MULTI-TENANT DATABASE SYSTEM, by Weissman et al., issued on Aug. 17, 2010, and hereby incorporated by reference in its entirety and for all purposes, teaches systems and methods for creating custom objects as well as customizing standard objects in a multi-tenant database system. In certain implementations, for example, all custom entity data rows are stored in a single multi-tenant physical table, which may contain multiple logical tables per organization. It is transparent to customers that their multiple “tables” are in fact stored in one large table or that their data may be stored in the same table as the data of other customers.

FIG. 7A shows a system diagram of an example of architectural components of an on-demand database service environment 900, in accordance with some implementations. A client machine located in the cloud 904, generally referring to one or more networks in combination, as described herein, may communicate with the on-demand database service environment via one or more edge routers 908 and 912. A client machine can be any of the examples of user systems 12 described above. The edge routers may communicate with one or more core switches 920 and 924 via firewall 916. The core switches may communicate with a load balancer 928, which may distribute server load over different pods, such as the pods 940 and 944. The pods 940 and 944, which may each include one or more servers and/or other computing resources, may perform data processing and other operations used to provide on-demand services. Communication with the pods may be conducted via pod switches 932 and 936. Components of the on-demand database service environment may communicate with a database storage 956 via a database firewall 948 and a database switch 952.

As shown in FIGS. 7A and 7B, accessing an on-demand database service environment may involve communications transmitted among a variety of different hardware and/or software components. Further, the on-demand database service environment 900 is a simplified representation of an actual on-demand database service environment. For example, while only one or two devices of each type are shown in FIGS. 7A and 7B, some implementations of an on-demand database service environment may include anywhere from one to many devices of each type. Also, the on-demand database service environment need not include each device shown in FIGS. 7A and 7B, or may include additional devices not shown in FIGS. 7A and 7B.

Moreover, one or more of the devices in the on-demand database service environment 900 may be implemented on the same physical device or on different hardware. Some devices may be implemented using hardware or a combination of hardware and software. Thus, terms such as “data processing apparatus,” “machine,” “server” and “device” as used herein are not limited to a single hardware device, but rather include any hardware and software configured to provide the described functionality.

The cloud 904 is intended to refer to a data network or combination of data networks, often including the Internet. Client machines located in the cloud 904 may communicate with the on-demand database service environment to access services provided by the on-demand database service environment. For example, client machines may access the on-demand database service environment to retrieve, store, edit, and/or process information.

In some implementations, the edge routers 908 and 912 route packets between the cloud 904 and other components of the on-demand database service environment 900. The edge routers 908 and 912 may employ the Border Gateway Protocol (BGP). The BGP is the core routing protocol of the Internet. The edge routers 908 and 912 may maintain a table of IP networks or ‘prefixes’, which designate network reachability among autonomous systems on the Internet.

In one or more implementations, the firewall 916 may protect the inner components of the on-demand database service environment 900 from Internet traffic. The firewall 916 may block, permit, or deny access to the inner components of the on-demand database service environment 900 based upon a set of rules and other criteria. The firewall 916 may act as one or more of a packet filter, an application gateway, a stateful filter, a proxy server, or any other type of firewall.

In some implementations, the core switches 920 and 924 are high-capacity switches that transfer packets within the on-demand database service environment 900. The core switches 920 and 924 may be configured as network bridges that quickly route data between different components within the on-demand database service environment. In some implementations, the use of two or more core switches 920 and 924 may provide redundancy and/or reduced latency.

In some implementations, the pods 940 and 944 may perform the core data processing and service functions provided by the on-demand database service environment. Each pod may include various types of hardware and/or software computing resources. An example of the pod architecture is discussed in greater detail with reference to FIG. 7B.

In some implementations, communication between the pods 940 and 944 may be conducted via the pod switches 932 and 936. The pod switches 932 and 936 may facilitate communication between the pods 940 and 944 and client machines located in the cloud 904, for example via core switches 920 and 924. Also, the pod switches 932 and 936 may facilitate communication between the pods 940 and 944 and the database storage 956.

In some implementations, the load balancer 928 may distribute workload between the pods 940 and 944. Balancing the on-demand service requests between the pods may assist in improving the use of resources, increasing throughput, reducing response times, and/or reducing overhead. The load balancer 928 may include multilayer switches to analyze and forward traffic.

In some implementations, access to the database storage 956 may be guarded by a database firewall 948. The database firewall 948 may act as a computer application firewall operating at the database application layer of a protocol stack. The database firewall 948 may protect the database storage 956 from application attacks such as structure query language (SQL) injection, database rootkits, and unauthorized information disclosure.

In some implementations, the database firewall 948 may include a host using one or more forms of reverse proxy services to proxy traffic before passing it to a gateway router. The database firewall 948 may inspect the contents of database traffic and block certain content or database requests. The database firewall 948 may work on the SQL application level atop the TCP/IP stack, managing applications' connection to the database or SQL management interfaces as well as intercepting and enforcing packets traveling to or from a database network or application interface.

In some implementations, communication with the database storage 956 may be conducted via the database switch 952. The multi-tenant database storage 956 may include more than one hardware and/or software components for handling database queries. Accordingly, the database switch 952 may direct database queries transmitted by other components of the on-demand database service environment (e.g., the pods 940 and 944) to the correct components within the database storage 956.

In some implementations, the database storage 956 is an on-demand database system shared by many different organizations. The on-demand database service may employ a multi-tenant approach, a virtualized approach, or any other type of database approach. On-demand database services are discussed in greater detail with reference to FIGS. 7A and 7B.

FIG. 7B shows a system diagram further illustrating an example of architectural components of an on-demand database service environment, in accordance with some implementations. The pod 944 may be used to render services to a user of the on-demand database service environment 900. In some implementations, each pod may include a variety of servers and/or other systems. The pod 944 includes one or more content batch servers 964, content search servers 968, query servers 982, file servers 986, access control system (ACS) servers 980, batch servers 984, and app servers 988. Also, the pod 944 includes database instances 990, quick file systems (QFS) 992, and indexers 994. In one or more implementations, some or all communication between the servers in the pod 944 may be transmitted via the switch 936.

The content batch servers 964 may handle requests internal to the pod. These requests may be long-running and/or not tied to a particular customer. For example, the content batch servers 964 may handle requests related to log mining, cleanup work, and maintenance tasks.

The content search servers 968 may provide query and indexer functions. For example, the functions provided by the content search servers 968 may allow users to search through content stored in the on-demand database service environment.

The file servers 986 may manage requests for information stored in the file storage 998. The file storage 998 may store information such as documents, images, and basic large objects (BLOBs). By managing requests for information using the file servers 986, the image footprint on the database may be reduced.

The query servers 982 may be used to retrieve information from one or more file systems. For example, the query system 982 may receive requests for information from the app servers 988 and then transmit information queries to the NFS 996 located outside the pod.

The pod 944 may share a database instance 990 configured as a multi-tenant environment in which different organizations share access to the same database. Additionally, services rendered by the pod 944 may call upon various hardware and/or software resources. In some implementations, the ACS servers 980 may control access to data, hardware resources, or software resources.

In some implementations, the batch servers 984 may process batch jobs, which are used to run tasks at specified times. Thus, the batch servers 984 may transmit instructions to other servers, such as the app servers 988, to trigger the batch jobs.

In some implementations, the QFS 992 may be an open source file system available from Sun Microsystems® of Santa Clara, Calif. The QFS may serve as a rapid-access file system for storing and accessing information available within the pod 944. The QFS 992 may support some volume management capabilities, allowing many disks to be grouped together into a file system. File system metadata can be kept on a separate set of disks, which may be useful for streaming applications where long disk seeks cannot be tolerated. Thus, the QFS system may communicate with one or more content search servers 968 and/or indexers 994 to identify, retrieve, move, and/or update data stored in the network file systems 996 and/or other storage systems.

In some implementations, one or more query servers 982 may communicate with the NFS 996 to retrieve and/or update information stored outside of the pod 944. The NFS 996 may allow servers located in the pod 944 to access information to access files over a network in a manner similar to how local storage is accessed.

In some implementations, queries from the query servers 922 may be transmitted to the NFS 996 via the load balancer 928, which may distribute resource requests over various resources available in the on-demand database service environment. The NFS 996 may also communicate with the QFS 992 to update the information stored on the NFS 996 and/or to provide information to the QFS 992 for use by servers located within the pod 944.

In some implementations, the pod may include one or more database instances 990. The database instance 990 may transmit information to the QFS 992. When information is transmitted to the QFS, it may be available for use by servers within the pod 944 without using an additional database call.

In some implementations, database information may be transmitted to the indexer 994. Indexer 994 may provide an index of information available in the database 990 and/or QFS 992. The index information may be provided to file servers 986 and/or the QFS 992.

In some implementations, one or more application servers or other servers described above with reference to FIGS. 7A and 7B include a hardware and/or software framework configurable to execute procedures using programs, routines, scripts, etc. Thus, in some implementations, one or more of application servers 50₁-50_{N} of FIG. 7B can be configured to initiate performance of one or more of the operations described above by instructing another computing device to perform an operation. In some implementations, one or more application servers 50₁-50_{N} carry out, either partially or entirely, one or more of the disclosed operations. In some implementations, app servers 988 of FIG. 7B support the construction of applications provided by the on-demand database service environment 900 via the pod 944. Thus, an app server 988 may include a hardware and/or software framework configurable to execute procedures to partially or entirely carry out or instruct another computing device to carry out one or more operations disclosed herein. In alternative implementations, two or more app servers 988 may cooperate to perform or cause performance of such operations. Any of the databases and other storage facilities described above with reference to FIGS. 6A, 6B, 7A and 7B can be configured to store lists, articles, documents, records, files, and other objects for implementing the operations described above. For instance, lists of available communication channels associated with share actions for sharing a type of data item can be maintained in tenant data storage 22 and/or system data storage 24 of FIGS. 7A and 7B. By the same token, lists of default or designated channels for particular share actions can be maintained in storage 22 and/or storage 24. In some other implementations, rather than storing one or more lists, articles, documents, records, and/or files, the databases and other storage facilities described above can store pointers to the lists, articles, documents, records, and/or files, which may instead be stored in other repositories external to the systems and environments described above with reference to FIGS. 6A, 6B, 7A and 7B.

While some of the disclosed implementations may be described with reference to a system having an application server providing a front end for an on-demand database service capable of supporting multiple tenants, the disclosed implementations are not limited to multi-tenant databases nor deployment on application servers. Some implementations may be practiced using various database architectures such as ORACLE®, DB2® by IBM and the like without departing from the scope of the implementations claimed.

It should be understood that some of the disclosed implementations can be embodied in the form of control logic using hardware and/or computer software in a modular or integrated manner. Other ways and/or methods are possible using hardware and a combination of hardware and software.

Any of the disclosed implementations may be embodied in various types of hardware, software, firmware, and combinations thereof. For example, some techniques disclosed herein may be implemented, at least in part, by computer-readable media that include program instructions, state information, etc., for performing various services and operations described herein. Examples of program instructions include both machine code, such as produced by a compiler, and files containing higher-level code that may be executed by a computing device such as a server or other data processing apparatus using an interpreter. Examples of computer-readable media include, but are not limited to: magnetic media such as hard disks, floppy disks, and magnetic tape; optical media such as flash memory, compact disk (CD) or digital versatile disk (DVD); magneto-optical media, and hardware devices specially configured to store program instructions, such as read-only memory (ROM) devices and random access memory (RAM) devices. A computer-readable medium may be any combination of such storage devices.

Any of the operations and techniques described in this application may be implemented as software code to be executed by a processor using any suitable computer language such as, for example. Java, C++ or Perl using, for example, object-oriented techniques. The software code may be stored as a series of instructions or commands on a computer-readable medium. Computer-readable media encoded with the software/program code may be packaged with a compatible device or provided separately from other devices (e.g., via Internet download). Any such computer-readable medium may reside on or within a single computing device or an entire computer system, and may be among other computer-readable media within a system or network. A computer system or computing device may include a monitor, printer, or other suitable display for providing any of the results mentioned herein to a user.

While various implementations have been described herein, it should be understood that they have been presented by way of example only, and not limitation. Thus, the breadth and scope of the present application should not be limited by any of the implementations described herein, but should be defined only in accordance with the following and later-submitted claims and their equivalents.

What is claimed is:

1. A method, comprising:
providing, for presentation via a client device, a first graphical user interface (GUI) having a first segment and a second segment presenting a set of user-selectable element types, each user-selectable element type of the set of user-selectable element types being associated with an icon and a corresponding set of computer-readable instructions;
processing a request for a set of computer-readable instructions in association with a location within a layout represented in the first segment of the GUI, the layout representing a process flow, the request being received from a client device;
obtaining, from the client device, a set of specifications in association with the request, the set of specifications including one or more sets of values, each set of values including a set of input values and corresponding set of output values;
responsive to the request, automatically generating a first set of computer-readable instructions configurable to:
maintain, for at least one set of values, a mapping between the set of input values and corresponding set of output values, and
responsive to receiving the set of input values of the set of values, identify the corresponding set of output values in the mapping and provide the identified set of output values; and
storing the first set of computer-readable instructions such that the first set of computer-readable instructions is associated with a first icon represented at the location within the layout, the first icon representing an element of the process flow.

2. The method of claim 1, further comprising:
transmitting an indication of the request to one or more recipients;
responsive to receiving a second set of computer-readable instructions from at least one of the recipients:
verifying that the second set of computer-readable instructions, during execution of the second set of computer-readable instructions, for each set of values, generates the set of output values responsive to receiving the corresponding set of input values; and
storing the second set of computer-readable instructions such that the second set of computer-readable instructions replaces the first set of computer-readable instructions.

3. The method of claim 1, further comprising:
identifying, within a storage medium, a second set of computer-readable instructions that, during execution of the second set of computer-readable instructions, for each set of values, generates the set of output values responsive to receiving the corresponding set of input values; and
storing the second set of computer-readable instructions such that it replaces the first set of computer-readable instructions.

4. The method of claim 1, further comprising:
verifying that a second set of computer-readable instructions, during execution of the second set of computer-readable instructions, for each set of values, generates the set of output values responsive to receiving the corresponding set of input values;
storing the second set of computer-readable instructions such that it replaces the first set of computer-readable instructions; and
executing the process flow such that the second set of computer-readable instructions is executed.

5. The method of claim 1, further comprising:
Executing the process flow such that the first set of computer-readable instructions is executed.

6. The method of claim 1, the first icon indicating that a request for a set of computer-readable instructions has been submitted in association with the element of the process flow.

7. The method of claim 1, the set of specifications comprising a description associated with the request.

8. A system comprising:
a database system implemented using a server system, the database system configurable to cause:
providing, for presentation via a client device, a first graphical user interface (GUI) having a first segment and a second segment presenting a set of user-selectable element types, each user-selectable element type of the set of user-selectable element types being associated with an icon and a corresponding set of computer-readable instructions;
processing a request for a set of computer-readable instructions in association with a location within a layout represented in the first segment of the GUI, the layout representing a process flow, the request being received from a client device;
obtaining, from the client device, a set of specifications in association with the request, the set of specifications including one or more sets of values, each set of values including a set of input values and corresponding set of output values;
responsive to the request, automatically generating a first set of computer-readable instructions configurable to:
maintain, for at least one set of values, a mapping between the set of input values and corresponding set of output values, and
responsive to receiving the set of input values of the set of values, identify the corresponding set of output values in the mapping and provide the identified set of output values; and
storing the first set of computer-readable instructions such that the first set of computer-readable instructions is associated with a first icon represented at the location within the layout, the first icon representing an element of the process flow.

9. The system of claim 8, the database system further configurable to cause:
transmitting an indication of the request to one or more recipients;
responsive to receiving a second set of computer-readable instructions from at least one of the recipients:
verifying that the second set of computer-readable instructions, during execution of the second set of computer-readable instructions, for each set of values, generates the set of output values responsive to receiving the corresponding set of input values; and
storing the second set of computer-readable instructions such that the second set of computer-readable instructions replaces the first set of computer-readable instructions.

10. The system of claim 8, the database system further configurable to cause:
identifying, within a storage medium, a second set of computer-readable instructions that, during execution of the second set of computer-readable instructions, for each set of values, generates the set of output values responsive to receiving the corresponding set of input values; and
storing the second set of computer-readable instructions such that it replaces the first set of computer-readable instructions.

11. The system of claim 8, the database system further configurable to cause:
verifying that a second set of computer-readable instructions, during execution of the second set of computer-readable instructions, for each set of values, generates the set of output values responsive to receiving the corresponding set of input values;
storing the second set of computer-readable instructions such that it replaces the first set of computer-readable instructions; and
executing the process flow such that the second set of computer-readable instructions is executed.

12. The system of claim 8, the database system further configurable to cause:
executing the process flow such that the first set of computer-readable instructions is executed.

13. The system of claim 8, the first icon indicating that a request for a set of computer-readable instructions has been submitted in association with the element of the process flow.

14. The system of claim 8, the set of specifications comprising a description associated with the request.

15. A computer program product comprising computer-readable program code capable of being executed by one or more processors when retrieved from a non-transitory computer-readable medium, the program code comprising computer-readable instructions configurable to cause:
providing, for presentation via a client device, a first graphical user interface (GUI) having a first segment and a second segment presenting a set of user-selectable element types, each user-selectable element type of the set of user-selectable element types being associated with an icon and a corresponding set of computer-readable instructions;
processing a request for a set of computer-readable instructions in association with a location within a layout represented in the first segment of the GUI, the layout representing a process flow, the request being received from a client device;
obtaining, from the client device, a set of specifications in association with the request, the set of specifications including one or more sets of values, each set of values including a set of input values and corresponding set of output values;
responsive to the request, automatically generating a first set of computer-readable instructions configurable to:
maintain, for at least one set of values, a mapping between the set of input values and corresponding set of output values, and
responsive to receiving the set of input values of the set of values, identify the corresponding set of output values in the mapping and provide the identified set of output values; and
storing the first set of computer-readable instructions such that the first set of computer-readable instructions is associated with a first icon represented at the location within the layout, the first icon representing an element of the process flow.

16. The computer program product of claim 15, the program code comprising computer-readable instructions further configurable to cause:
transmitting an indication of the request to one or more recipients,
responsive to receiving a second set of computer-readable instructions from at least one of the recipients:
verifying that the second set of computer-readable instructions, during execution of the second set of computer-readable instructions, for each set of values, generates the set of output values responsive to receiving the corresponding set of input values; and
storing the second set of computer-readable instructions such that the second set of computer-readable instructions replaces the first set of computer-readable instructions.

17. The computer program product of claim 15, the program code comprising computer-readable instructions further configurable to cause:
identifying, within a storage medium, a second set of computer-readable instructions that, during execution of the second set of computer-readable instructions, for each set of values, generates the set of output values responsive to receiving the corresponding set of input values; and
storing the second set of computer-readable instructions such that it replaces the first set of computer-readable instructions.

18. The computer program product of claim 15, the program code comprising computer-readable instructions further configurable to cause:
verifying that a second set of computer-readable instructions, during execution of the second set of computer-readable instructions, for each set of values, generates the set of output values responsive to receiving the corresponding set of input values;
storing the second set of computer-readable instructions such that it replaces the first set of computer-readable instructions; and
executing the process flow such that the second set of computer-readable instructions is executed.

19. The computer program product of claim 15, the program code comprising computer-readable instructions further configurable to cause:
executing the process flow such that the first set of computer-readable instructions is executed.

20. The computer program product of claim 15, the first icon indicating that a request for a set of computer-readable instructions has been submitted in association with the element of the process flow.
